(19) United States
(12) Patent Application Publication
(10) Pub. No.: US 2002/0081424 A1
(43) Pub. Date: Jun. 27, 2002

(54) Plastic film with optical effect

(76) Inventors: Cornelius Haas, Friedrichshafen (DE); Karl Holdik, Auburn Hills, MI (US); Juergen Sander, Markdorf (DE); Werner Scherber, Bermatingen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/026,591

(22) Filed: Dec. 19, 2001

(30) Foreign Application Priority Data
Dec. 22, 2000 (DE) 100 64 521.6-43

(51) Int. Cl. B32B 5/16

(52) U.S. Cl. 428/323; 428/403; 264/1.34

(57) ABSTRACT

The present invention relates to a decorative plastic film for the surface treatment, in particular, of vehicle bodies and building facades. It has a micro- or nano-scale structure, in which micro-or nano-scale particles (4) are introduced in uniform shape, size, and orientation into a transparent polymer substrate (3), so that the optically perceptible effect is produced exclusively or largely by optical effects in the collective arrangement of the particles (4).

Priority is claimed to German Patent Application No. 100 64 521.6-43, which is hereby incorporated by reference herein.

### BACKGROUND INFORMATION

The present invention relates to plastic films having color effects for treating everyday objects, in particular, for the surface coating of vehicle bodies and building facades, as well as a method for manufacturing them.

The paint finish of a motor vehicle and of other objects represents an important sign of quality. In addition to the technical requirements of corrosion protection and mechanical stability, the choice of color and the optical quality of the paint finish are intended to convey individuality, prestige, and design aspects.

However, the technical possibilities for producing specific effects are very limited. In addition to standard paint finishes, so-called metallic finishes are available today which contain finely distributed metal particles and which as a result yield a shinier finish.

Further possibilities arise if, instead of the simple metal flakes, coloring particles are embedded. One familiar approach is to provide plate-shaped particles made of glass or glimmer (mica) with interference-capable layers and therefore to achieve a direction-dependent color impression. Products of this type have been offered for years by the companies Merck and BASF, among others, and have established themselves above all in the application areas of cosmetics, packing products, advertising, design, etc. In the vehicle area as well, these developments have led to interesting results, which can be seen again and again at professional fair exhibits or which are manufactured in limited numbers, but which heretofore have not been introduced as a mass- produced paint finish. The main reasons for this are the relatively high costs for manufacturing the interference layer and preparing it as pigment. Further typical disadvantages are the color fidelity and reproducibility of these methods. It should be noted in general that the manufacturing costs of the pigment rise sharply as quality and reliability improve and that they rapidly reach prohibitive levels in large-surface applications.

### SUMMARY OF THE INVENTION

An objective of the present invention is to provide high-quality surface coatings, which make it possible to produce novel color impressions and designer effects and which are suitable for rational production methods of large surfaces.

The present invention provides a decorative plastic film for the surface treatment, in particular of vehicle bodies and building facades, wherein the film has a micro- or nano-scale structure, micro- or nano-scale particles (4) being introduced in uniform shape, size, and orientation into a transparent polymer substrate (3), and the optically perceptible effect is produced exclusively or substantially by optical effects in the collective arrangement of the particles (4).

The solution according to the present invention lies in generating the color effect, in particular, direction-dependent colorings, or a direction-dependent darkening of a clear film substrate solely or largely using structural effects. Known methods employ conventional color pigments, i.e., substances for which a typical color, a specific degree of reflection, or an interference effect can be assigned to the individual particle on the basis of its size (in particular, much larger than the length of a lightwave) and its chemical composition. In contrast to this, the present invention is based on optical effects in nano-scale or micro-scale particles, which have no inherent color due to their dimensions (comparable or smaller than the length of the lightwave, i.e., specifically, smaller than one micrometer or in the order of magnitude of one micrometer), but which only produce the desired effect on the basis of their collective arrangement. Examples of color impressions of this type, which are mainly generated by the form and size of particles and less as a result of their material qualities, are the dispersion in the smallest particles having minimal extinction (the blue of the sky), the dispersion in larger particles having greater extinction (intensive colors of gold colloids), interference in combined layered media, and birefringence and dichroism in oriented rod-shaped particles.

If the present discussion involves nano-scale or micro-scale particles or structures, it should be understood thereby that at least one structural dimension of these particles or structures lies in the nano- or micrometer range, and below, for simplicity's sake, will be termed “microstructures.”

Although the aforementioned classical phenomena are generally known, they are not technically available for decorative coatings of larger objects because it has heretofore not seemed possible to introduce the particles into a paint layer or plastic film in a simple and controllable manner in a suitable size, form, concentration, and orientation.

One advantage of the present invention can also be seen in the fact that the surface treatment is achieved by applying a prefabricated film, this film being manufactured on the basis of semifinished films, film-like paint layers, polymer or paint layers applied to substrate films, or similar configurations. It is easy to see that an automated manufacturing process of a film makes possible an incomparably greater degree of color homogeneity and reproducibility than an individual dipping or injection method, especially if complex solid pigments having a defined orientation and concentration are to be embedded. Especially in vehicle construction, cost advantages and greater flexibility with regard to future ecological requirements are possible using prefabricated films in place of conventional vehicle painting.

The methods for manufacturing the color-effect films according to present invention include a plurality of steps, involving both transfer techniques as well as application techniques. The first step concerns the production of a suitable micro- or nano-scale structure on an auxiliary surface or a master (matrix). Subsequently, the transfer of the structural elements onto a film-like polymer substrate takes place (transfer) or, alternatively, only the structural information is applied to a polymer substrate (replication). Further optional method steps can be carried out for strengthening the optical effects and for the secondary treatment and further processing of the polymer substrate.

### BRIEF DESCRIPTION OF THE DRAWINGS

The various method steps are described in greater detail below by way of example and on the basis of schematic drawings. The following are the contents:

FIG. 1 a replication method for manufacturing the color-effect film according to the present invention in five method steps:

a: aluminum layer 1 having porous oxide 2

b: shaping a mold 4 having rod-shaped surface 5

c: hot stamping a polymer substrate 3

d: removing the polymer substrate having pore-like recesses 7

e: embedding color particles 4.

FIG. 2 a transfer method for manufacturing the color-effect film according to the present invention, having the method steps:

a: aluminum film 1 having porous oxide 2

b: embedding particles 4

c: partial removal of oxide layer 2

d: bonding to polymer substrate 3

e: removing aluminum film 1 together with the residual oxide layer.

### DETAILED DESCRIPTION

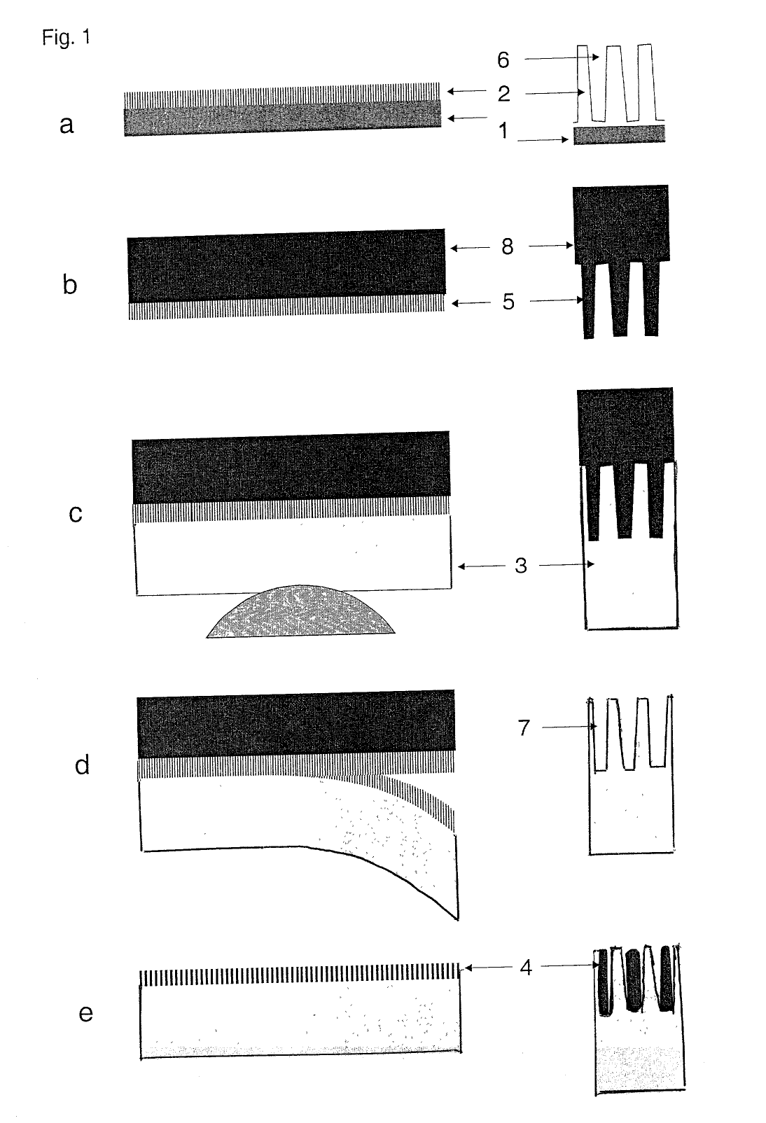

According to the replication method depicted in FIG. 1, in step a, a uniform surface structure is produced. In principle, for generating the finest uniform structures, the known lithographic structuring methods can be used on the basis of x-ray and electron beam irradiation. However, methods that are based on self-organizing mechanisms may be more suitable for the present objective; these mechanisms generally do not yield strictly ordered structures, but they can be applied in a cost-effective manner to larger and more complexly shaped surfaces. As a preferred example, the generally known anodic oxidation of aluminum (aluminum layer 1 in step a) and other metals should be mentioned. By appropriately choosing the electrolyte and the other anodizing parameters, an oxide layer 2 having very regular cylindrical pores 6 can be produced. The attainable structural dimensions, i.e., the separation and the diameter of the pores, are between roughly 10 nm and 1 micrometer, i.e., in the wavelength range in which the cited optical effects occur.

Subsequently (FIG. 1, b), the structural information of the aluminum oxide layer is transferred to a mold suitable for the subsequent production steps, i.e., a press roll or a tool mold 8. This occurs in accordance with known molding techniques, e.g., electroforming, it being advisable to observe the methods and measures customary in this specialized area with respect to material selection, pre- and post-processing, surface coating, etc., although they are not further mentioned here. From the pore-like surface of the starting layer, a rod-shaped negative image 5 arises in the mold surface.

For transferring the microstructure of the mold onto a polymer substrate, a plurality of possibilities can be considered:

hot stamping a film in continuous operation (FIG. 1, step c);

injecting into a mold, which carries the micro-structured surface, having a thermoplast;

filling a micro-structured mold or a calender using a monomer or partially cross-linked polymer and subsequent polymerization using chemical, thermal, or UV starters, as well as combinations;

transferring the microstructure in a press or stamping process. The structured mold surface, in this context, functions as a roll-shaped pressure matrix so as to apply a liquid or pasty substance to the polymer substrate, which subsequently is brought into contact with a monomer. Depending on the material pairing of polymer substrate and monomer, the substance to be imprinted is selected so as to have either strongly cross-linking (adhesive agents) or strongly decross-linking properties (release agents). On the basis of the surface effects, droplet-like structures are created, which are polymerized in accordance with known methods, and in this way a 3-dimensional replication or negative form of the matrix arises.

Differing variants and combinations of these basic methods, generally known from plastics technology, are also applicable.

Well-suited as materials for the polymer substrate, on account of their processability, optical properties (transparence), and stability, are especially plastics such as PMMA (polymethyl methacrylate) and PU (polyurethane), but also polymers such as PE (polyethylene), PP (polypropylene), PVC (polyvinyl chloride), PC (polycarbonate), PET (polyethylene terephthalate), PVDF (polyvinylidene floride), polyester, ABS (acrylonitrile-butadien-styrene), ASA (acrylonitrile-styrene-acrylester). Copolymers of these compounds also can be considered.

In the next treatment step, after being removed from the tool mold (FIG. 1, d), the surface structure embedded in the polymer substrate is used to form the actual coloring particles, for which purpose there are also a multiplicity of approaches available. On the basis of substrates that are available in film form, suitable for this process step are, for example, vacuum coating methods, i.e., vapor deposition or cathode sputtering, which yield very cost-effective and uniform coatings in continuous operation. In this context, it is important to introduce substances whose refractive index n deviates significantly from that of polymer substrate matrix 3, i.e., preferably highly-refractive oxidic, semiconducting or metallic materials, it being important that absorption coefficient k (the imaginary part of refractive index) not lie at too high a level, to avoid excessive light absorption in the coating. As a result of the choice of material and of the coating thickness, the most varied color tones and effects can be achieved, the optical effect beginning even in metals in the form of very thin films of a few atom layers. Rare metals, in particular gold, yield very strong color effects due to their special optical constants that are coupled to electrical conductivity, but the method is in no way limited to these classes of material. Suitable above all are transparent metal oxides having a higher refractive index such as Al₂O₃, Bi₂O₃, CeO₂, Fe₂O₃, In₂O₃, SnO₂, Ta₂O₅, TiO₂. The oxides can be used directly as starting materials for the coating process, but it is often more expedient from the process engineering point of view to vaporize or to sputter the corresponding metals and subsequently to oxidize them in the gas phase or after the deposition. In the case of some metals and at lower coating thicknesses, this occurs spontaneously in response to the presence of air. Similarly well suited as a starting material for coloring particles are semiconductors such as Si and Ge due to their favorable optical constants (high n/k ratio) and advantages in the area of coating engineering.

The aforementioned powerful absorption effect of metals can also be exploited in the meaning of the present invention. This effect arises most of all when metals in the form of fine fibers and having small numerical density are embedded, which succeeds as a result of the controlled adjustment of the aluminum oxide matrix (large pore distances) and of the vaporizing of small material quantities (slightly diagonal with respect to the pore axis). Structures of this type, viewed vertically, demonstrate no particular color effect, but they darken in response to an increasingly planar angle. In connection with a standard color paint coating underneath, interesting optical effects are also generated, in particular in response to directed incident light or solar radiation (colored-hueless-transition).

As a process-engineering variant for vacuum coating, a special form of the chemical deposition of metals can be used (step e). As is customary in the electroplating of plastics, first the surface to be coated is activated using an ionogenic or colloidal solution containing palladium. On activated palladium seeds it is possible subsequently to deposit larger metal particles 4 chemically, i.e., without current. These methods are particularly effective in the meaning of the present invention for depositing isolated structural elements, because the germination in the recesses of the molded nano-structured surface can be processed in a very controlled and uniform manner because of capillary forces. Further steps such as reducing and fixing the palladium seeds, surface rinsing, re-etching the deposited metal particles, inter alia, can be used to influence the shape, size, and number of the embedments and thus to modify the resulting color impressions. For the technical applications of the currentless metallization, metals such as copper and nickel are generally used. In addition, the solution according to the present invention can also have recourse to other metals that can be chemically deposited, because only small quantities of material and short process times are necessary in these cases, for example rare metals or elements from the above-mentioned material groups such as indium and tin, and their subsequent conversion into the corresponding oxides.

Alternatively to the coating of a molded polymer substrate, it is also possible according to the present invention to use other methods. If, for example, the structured surface is filled out with or joined to a second transparent polymer substance and the substance possesses a higher refraction index than the substrate film, then, similarly, color effects are created on the regularly arranged border areas as a result of interference. A similar effect is achieved by an arrangement in which the structured film is directly bonded to a planar base, so that regular nano-scale air pockets arise. The color contrasts that can be achieved in this way are not as intensive as when metals or oxides are used, but they are well suited for emphasizing or setting off conventional colors and finishes, which can be used in lower layers.

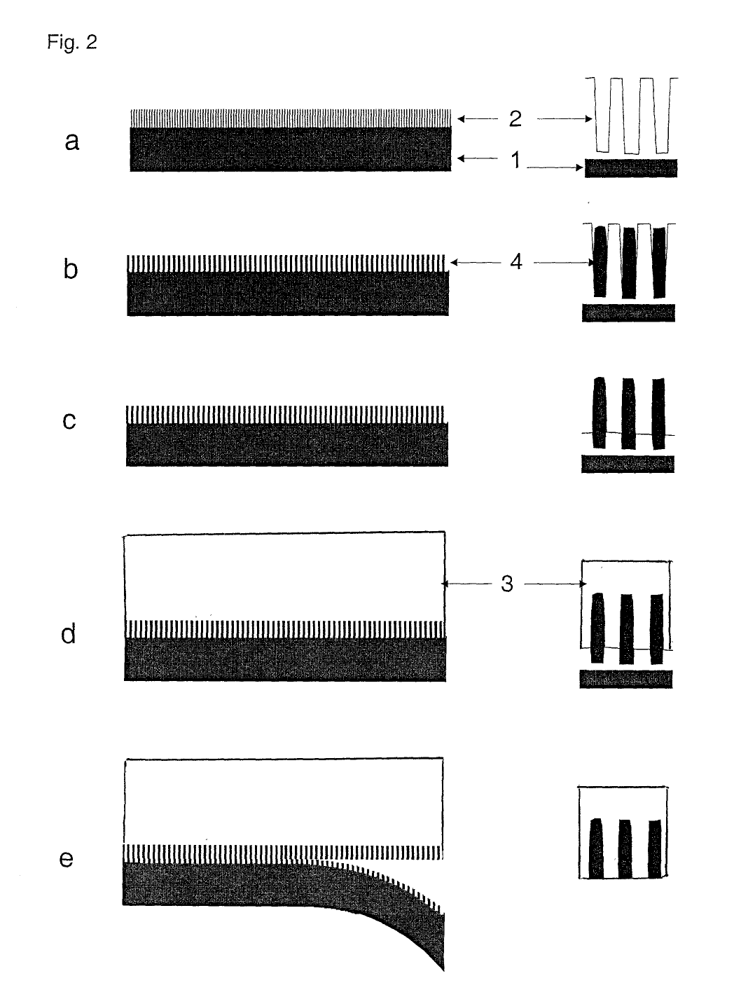

Further possibilities arise if the color-determining elements are produced not on the pre-structured plastic substrate but rather already on the auxiliary substrate, and subsequently are embedded in the polymer substrate in collective form (transfer method). An exemplary method in this regard is depicted in FIG. 2. Initially, as was described above, a nano-structured auxiliary layer is produced (step a) preferably using anodic oxidation of thin aluminum film 1 or of an aluminized plastic film. Then metal needles, e.g. made of nickel, tin, indium, or zinc, are embedded in the pores of oxide layer 2 using electroplating methods (step b). Rare metals such as gold, platinum, silver, inter alia, are also suitable, it being possible for them to undergo epitaxial growth in the form of thin-wall tubes if the process is managed appropriately. The deposition process is terminated as soon as the metal needles or tubes extend substantially (roughly 100 nm or more) beyond the surface of the oxide mask, but before they grow together into a solid layer. This is not successful in the case of all metals or the case of very fine pores; in these cases, the oxide mask after the metal deposition can be partially etched away chemically (step c), so that a layer composed of free-standing metal particles also arises. Optionally, a partial or complete transfer of the metal particles into the oxide phase can be carried out (in the case of very fine structures, this occurs under certain circumstances spontaneously in the air), e.g., using a subsequent anodic oxidation or a plasma treatment in an oxidizing atmosphere. The auxiliary substrate then is bonded to transparent polymer substrate 3 by gluing, melting, welding, laminating, etc., techniques (step d), and subsequently (step e) the aluminum film including the (residual) oxide skin is mechanically separated or chemically etched away.

In accordance with the rules of optics, it is necessary in designing the color-producing structures to observe specific boundary conditions. In using very small particles (in comparison to the wavelength of visible light), the particles in the polymer matrix form a so-called composite medium, i.e., a layer zone, to which a homogeneous effective refraction index can be assigned. This effective refraction index results, in accordance with known mixing formulas, from the optical constants of the partners; in metal embedments the result in this manner is a relatively high refraction index and absorption coefficient, in the case of oxides and semiconductors, it is an average one, and in the case a purely organic mixed structures or air pockets, it is an especially small refraction index. In one medium of this type, it is possible to produce a color effect by interference, if the layer density in relation to the wavelength takes on specific values that are a function of the effective refraction index. Depending on the type and density of the embedments, the layer must therefore be set at a specific density that is capable of generating interference. In replication methods, this takes place via the density of the aluminum oxide matrix, i.e., the pore depth, or the height of structure in the mold, and in transfer methods, it takes place via the height of the free-standing structural elements. In the case of larger particles, dispersion effects increasingly come to the fore, overriding the interference effect.

The polymer substrate provided with color-determining structures through replication or using a transferred layer is subsequently further processed and applied in accordance with customary methods such as deep drawing, back spraying, laminating, gluing, heat treating, radiation curing, etc., which cannot be described here in detail. Because the color effects according to the present invention are primarily brought about by dispersion and interference, suitable bases are above all black or dark finishes or surfaces. Brighter backgrounds send back a greater light component, which overrides the dispersed and reflected light beams from the embedded particles and weakens the color contrast. In the case of finely distributed metal structures, which tend to produce a direction-dependent shadow effect, the color of the background is not so important, and here bright colors can also be used.

Because the color effects described are linked to the collective arrangement of the embedded particles, the result is a further important feature of the present invention, which can be observed especially in the case of very small structural dimensions. As was mentioned above, the volume concentration of small particles is codeterminative for the effective refraction index of the composite medium, i.e., via the particle density it is also possible to control the spectral position and therefore the color of an interference layer, in contrast to conventional finishes. This becomes noticeable in biaxially curved surfaces, because as a result of the deformation a thinning of the material necessarily takes place. In addition to the aforementioned direction-dependent color effects, the result in this context is an additional form-dependent color and brightness shift on curved surfaces, which can be exploited very effectively, for example, in paint finishes of vehicle bodies. On the one hand, in the case of a discreet adjustment of the effect, an interesting emphasis of the vehicle shape (plasticity) is produced, and on the other hand, powerful contemporary color effects are also possible. As the particle size increases, the dispersion effects on the individual particles predominate over the collective effect of the medium, so that the percentage of the various phenomena as a result of the structural size can gradually be adjusted to the specific object and the desired overall decorative effect.

What is claimed is:

1. A plastic film with an optically perceptible effect for providing a surface with a micro- or nano-scale base structure comprising:
a transparent polymer substrate; and
micro- or nano-scale particles of uniform shape, size, and orientation in the transparent polymer substrate so as to define a collective arrangement of the particles, the optically perceptible effect being produced by optical effects in the collective arrangement.

2. The plastic film as recited in claim 1 wherein the optical effects of the collective arrangement include at least one of direction-dependent dispersion, dichroism, interference, and absorption.

3. The plastic film as recited in claim 1 wherein the particles include at least one of metals, metal oxides, and semiconductors.

4. The plastic film as recited in claim 1 wherein the particles include a transparent polymer substance.

5. The plastic film as recited in claim 1 wherein the particles have a refractive index different with respect to the polymer substrate.

6. The plastic film as recited in claim 1 wherein the polymer substrate has nano-scale pores, the particles being located in the pores.

7. The plastic film as recited in claim 1 wherein the embedded particles have anisotropic shapes and the longitudinal axis of the elements is oriented perpendicular to the surface.

8. The plastic film as recited in claim 1 wherein the film is used for one of vehicle bodies and building facades.

9. A plastic film with an optically perceptible effect for providing a surface with a micro- or nano-scale base structure comprising:
a transparent polymer substrate; and
micro- or nano-scale hollow spaces of uniform shape, size, and orientation in the transparent polymer substrate so as to define a collective arrangement of the spaces, the optically perceptible effect being produced by optical effects in the collective arrangement.

10. The plastic film as recited in claim 9 wherein the hollow spaces have anisotropic shapes and the longitudinal axis of the hollow spaces is oriented perpendicular to the surface.

11. A method for manufacturing plastic film as recited in claim 1 comprising: first producing the collective arrangement of the particles on an auxiliary substrate and then transferring the collective arrangement to the polymer substrate.

12. The method as recited in claim 11 wherein the auxiliary substrate is provided with a porous oxide layer, the particles being embedded in pores of the auxiliary substrate galvanically, the particles forming a metal structure, the metal structure being transferred in a uniform height to the polymer substrate through gluing, melting, or laminating, and finally the auxiliary substrate being removed mechanically or chemically.

13. The method as recited in claim 12 including a partial removal of the oxide layer.

14. The method as recited in claim 11 wherein the porous oxide layer is generated using a self-organizing mechanism.

15. The method as recited in claim 14 wherein the self-organizing mechanism includes redissolving anodization of aluminum.

16. The method as recited in claim 12 wherein the auxiliary substrate is provided with a porous oxide layer in an oxide phase, a partial or complete transfer of the metal particles embedded in the pores being carried out in the oxide phase.

17. The method as recited in claim 16 wherein the transfer is through a subsequent anodic oxidation or plasma treatment in an oxidizing atmosphere.

18. A method for manufacturing the plastic film as recited in claim 1 comprising: generating a porous surface structure, transferring the surface structure using a molding process to the polymer substrate, and subsequently coating the molded structure using a physical or chemical deposition method.

19. The method as recited in claim 18 wherein the molding process takes place using plastics processing.

20. The method as recited in claim 19 wherein the plastics processing includes hot stamping, impressing, injection molding, or mold technology.

21. The method as recited in claim 18 wherein the porous surface structure is generated using a self-organizing mechanism.

22. The method as recited in claim 21 wherein the self-organizing mechanism includes redissolving anodization of aluminum.

23. The method as recited in claim 18 wherein the porous surface structure is transferred using a first molding process to a mold and the surface structure of the mold is transferred using a further molding process to the polymer substrate.

24. The method as recited in claim 23 wherein the mold is a tool mold or a press roll.
